(19) United States
(12) Patent Application Publication
(10) Pub. No.: US 2020/0172751 A1
(43) Pub. Date: Jun. 4, 2020

(54) NON-AQUEOUS INK COMPOSITIONS

(71) Applicant: Hewlett-Packard Development Company, L.P., Spring, TX (US)

(72) Inventors: Dana ALGAIER, Corvallis, OR (US); Thomas W. BUTLER, Corvallis, OR (US); Audrey DICKINSON, Corvallis, OR (US)

(73) Assignee: Hewlett-Packard Development Company, L.P., Spring, TX (US)

(21) Appl. No.: 16/620,333

(22) PCT Filed: Oct. 23, 2017
(86) PCT No.: PCT/US2017/057896

§ 371 Date: Dec. 6, 2019

(51) Int. Cl. C09D 11/36; C09D 11/326; B41M 5/00

(52) U.S. Cl. CPC C09D 11/36; B41M 5/0064; B41M 5/0047; C09D 11/326

(57) ABSTRACT

The present disclosure is drawn to non-aqueous ink compositions. The non-aqueous ink compositions can include from 55 wt % to 95 wt % of a mono-alcohol solvent, from 3 wt % to 15 wt % of a polymeric binder, and from 2 wt % to 7 wt % carbon black pigment. The mono-alcohol solvent can include ethanol and C3-C6 mono-alcohol having an ethanol to C3-C6 mono-alcohol weight ratio of 1:1 to 10:1. The polymeric can have a weight average molecular weight ranging from 1,500 Mw to 15,000 Mw. The carbon black pigment can be dispersed by a polymeric dispersing agent associated with a surface of the carbon black pigment.

### BACKGROUND

Inkjet printing has become a popular way of recording images on various media, including nonporous substrates. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions.

### BRIEF DESCRIPTION OF DRAWINGS

Additional features and advantages of the disclosure will be apparent from the detailed description which follows, taken in conjunction with the accompanying drawings, together illustrating, by way of example, features of the present technology. It should be understood that the figures are representative of examples of the present disclosure and should not be considered as limiting the scope of the disclosure.

FIG. 1 depicts an example method of printing in accordance with the present disclosure; and

FIG. 2 graphically presents an example weight percentage of colorant compared against optical density for pigmented inks and a dye based ink in accordance with the present disclosure.

### DETAILED DESCRIPTION

Inkjet printing on non-porous substrates can present challenges due to the low surface energy of the substrate. These challenges are particularly prevalent in the area of product identification. For example, inkjet printing of barcodes can benefit from an ink composition that is durable and exhibits high optical density. Historically, this type of application has utilized inks having solvent black dye and polymeric binder; however, as the amount of polymeric binder increases, the viscosity of the ink also increases resulting in jettability issues. In addition, when solvent black dye is used as a colorant for product identification, often, a second dye is used to adjust the hue value. The optical density of dye based ink can be limited by the solubility of the dyes and the nature of the dyes included. When reading barcodes, increased contrast between the substrate and the ink can assist barcode reader accuracy, and thus, higher optical density inks can translate into improved functionality for these types of applications.

In accordance with this, the present disclosure relates generally to a non-aqueous ink composition, an inkjet printing system, and a method of printing. In one example, the non-aqueous ink composition can include from 55 wt % to 95 wt % mono-alcohol solvent, from 3 wt % to 15 wt % polymeric binder, and from 2 wt % to 7 wt % carbon black pigment. In one example, the mono-alcohol solvent can include ethanol and C₃-C₆ mono-alcohol and can have an ethanol to C₃-C₆ mono-alcohol weight ratio of 1:1 to 10:1, the polymeric binder can have a weight average molecular weight ranging from 1,500 Mw to 15,000 Mw, and the carbon black pigment can be dispersed by a polymeric dispersing agent associated with a surface of the carbon black pigment. In further detail, the ethanol can be present in the non-aqueous ink composition at from 45 wt % to 85 wt % and the C₃-C₆ mono-alcohol can be present in the non-aqueous ink composition at from 10 wt % to 50 wt %. In yet another example, the C₃-C₆ mono-alcohol can be one or more straight chained mono-alcohols, e.g., the C₃-C₆ mono-alcohol can include 1-butanol, a combination of 1-butanol and 1-propanol, etc. In one example, the non-aqueous ink composition can include from 0.5 wt % to 15 wt % of a carbonyl co-solvent. Other types of co-solvents may be present in other examples. The polymeric binder can be styrene acrylic copolymer, a hydrogenated phenyl ketone resin, or a combination thereof. In a further example, the carbon black can be present at from 3 wt % to 6 wt % in the non-aqueous ink composition and the non-aqueous ink composition can be devoid of dye.

In another example, an inkjet printing system can include a non-porous polymeric substrate and a non-aqueous ink composition. The non-aqueous ink composition can include from 55 wt % to 95 wt % mono-alcohol solvent, from 3 wt % to 15 wt % polymeric binder, and from 2 wt % to 7 wt % carbon black pigment. In one example, the mono-alcohol solvent can include ethanol and C₃-C₆ mono-alcohol having an ethanol to C₃-C₆ mono-alcohol weight ratio of 1:1 to 10:1, the polymeric binder can have a weight average molecular weight ranging from 1,500 Mw to 15,000 Mw, and the carbon black pigment can be dispersed by a polymeric dispersing agent associated with a surface of the carbon black pigment. In further detail, the non-porous polymeric substrate can be a biaxially-oriented substrate, and/or the non-porous polymeric substrate can be a polyvinyl chloride, a polyethylene, a polyethylene terephthalate, a polyproplyene, a polystyrene, a polylactic acid, or a polymeric blend thereof. In a further example, the C₃-C₆ mono-alcohol can include 1-butanol.

In one example, a method of printing can include jetting a non-aqueous ink composition onto a non-porous polymeric substrate to form a printed image thereon. The non-aqueous ink composition can include from 55 wt % to 95 wt % mono-alcohol solvent, from 3 wt % to 15 wt % polymeric binder, and from 2 wt % to 7 wt % carbon black pigment. In one example, the mono-alcohol solvent can include ethanol and C₃-C₆ mono-alcohol having an ethanol to C₃-C₆ mono-alcohol weight ratio of 1:1 to 10:1, the polymeric binder can have a weight average molecular weight ranging from 1,500 Mw to 15,000 Mw, and the carbon black pigment can be dispersed by a polymeric dispersing agent associated with a surface of the carbon black pigment. In further detail, the non-porous polymeric substrate can be a biaxially-oriented substrate, and/or can be a polyvinyl chloride, a polyethylene, a polyethylene terephthalate, a polyproplyene, a polystyrene, a polylactic acid, or a polymer blend thereof. In another example, the C₃-C₆ mono-alcohol can include 1-butanol.

It is noted that when discussing the non-aqueous ink composition, the inkjet printing system, and the method of printing, each of these discussions can be considered applicable to other examples whether or not they are explicitly discussed in the context of that example unless expressly indicated otherwise. Thus, for example, in discussing a C₃-C₆ mono-alcohol related to a non-aqueous ink composition, such disclosure is also relevant to and directly supported in context of the inkjet printing system, the method of printing, and vice versa.

As mentioned, the mono-alcohol solvent in the ink composition can include ethanol and a C₃-C₆ mono-alcohol. In one example, the ethanol can be a denatured ethanol. The ethanol can be present at from 55 wt % to 95 wt %, from 55 wt % to 85 wt %, from 60 wt % to 90 wt %, or from 65 wt % to 80 wt %. In further detail, exemplary C₃-C₆ mono-alcohol can include propanols (e.g., 1-propanol and/or isopropanol), butanols (e.g., 1-butanol, isobutanol, and/or tert-butanol), pentanols (e.g., 1-pentanol, isopentanol, 2-methyl-2-butanol, etc.), and/or hexanols (e.g., 1-hexanol, isohexanol, 2-methyl-2-pentanol, etc.). In one example, the C₃-C₆ mono-alcohol can be 1-butanol, 1-propanal, or a combination thereof. 1-butanol, for example, works particularly well at improving dry time and/or contributing to faster durability in accordance with examples of the present disclosure, and thus, can be used alone, or combined with other C₃-C₆ mono-alcohols. In other examples, the C₃-C₆ mono-alcohol can be (or include) one or more straight chained mono-alcohol (e.g., 1-propanol, 1-butanol, 1-pentanol, and/or 1-hexanol). In some examples, the C₃-C₆ mono-alcohol can decrease the dry time of the ink composition when compared to a comparative ink composition that incorporates an additional amount of ethanol in place of the C₃-C₆ mono-alcohol. In one example, the amount of the C₃-C₆ mono-alcohol can be present at from 10 wt % to 50 wt %. In other examples the amount of the C₃-C₆ mono-alcohol can range from 10 wt % to 30 wt %, or from 15 wt % to 25 wt %. The weight ratio of the ethanol to the C₃-C₆ mono-alcohol can also vary. In some examples the weight ratio can be from 1:1 to 10:1, from 2:3 to 10:1, from 2:1 to 5:1, or from 3:1 to 4:1.

The polymeric binder in the ink composition can vary. In one example, the polymeric binder can be a styrene acrylic copolymer, a hydrogenated phenyl ketone resin, or a combination thereof. The hydrogenated phenyl ketone can be effective for use in particular in some examples. In one example, upon hydrogenation, the side chain can become a benzyl alcohol group attached to the polymer chain at a carbon atom between the phenyl group and the alcohol group. More generally, Formula I below depicts an example phenyl ketone resin and the conversion to its hydrogenated form.

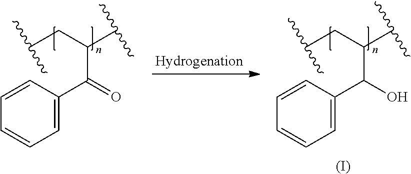

In this example, n can be any suitable number used to provide a polymeric binder having a weight average molecular weight from 1,500 Mw to 15,000 Mw, e.g., about 10 to about 115. In other examples, the styrene acrylic copolymer and the hydrogenated phenyl ketone resin, among others, include aromatic moieties, which can often be included in accordance with examples of the present disclosure.

The polymeric binder(s) can have a weight average molecular weight ranging from 1,500 Mw to 15,000 Mw. In further examples, the weight average molecular weight of the polymeric binder can vary from 3,000 Mw to 12,000 Mw; from 1,500 Mw to 8,000 Mw; or from 3,000 Mw to 8,000 Mw. A polymeric binder having a low weight average molecular weight (equal to or less than 15,000 Mw) can provided acceptable adhesion of the pigmented ink to the nonporous polymeric substrate, for example. The amount of the polymeric binder can also vary. In some examples, the polymeric binder can be present at from 3 wt % to 15 wt %. In other examples, the polymeric binder can be present at from 3 wt % to 10 wt %, or from 4 wt % to 8 wt %.

Turning now to the carbon black pigment, which is provided as a black colorant. The carbon black pigment can, for example, be a solvent borne pigment. In one example, the carbon black pigment can be a powdered pigment. In another example, the carbon black pigment can be surface treated using a treatment such as a corona treatment, ion treatment, plasma treatment, or the like. Exemplary commercially available carbon black pigments can include XPB 561 or NIPex® 160 IQ (both available from Orion® Engineered Carbons, GmbH (Germany), Special Black 40 (The Cary Company, Illinois), or the like. The carbon black pigment can be present at from 2 wt % to 7 wt %, or 3 wt % to 6 wt %. In other examples, the carbon black pigment can be present at from 3 wt % to 5 wt % or from 3 wt % to 4 wt %. In some examples, when the carbon black pigment on a non-porous substrate, the black optical density (KOD) that is printed using the ink composition can be at least 1. In some example, this KOD can be achieved using at least 3 wt % of the carbon black pigment, e.g., from 3 wt % to 6 wt %. In other example, the ink composition can be devoid of a dye.

The carbon black pigment can be dispersed by a polymeric dispersing agent associated with a surface of the carbon black pigment. In some examples the polymeric dispersing agent can associate with the carbon black pigment by an attraction based on charge. For example, the carbon black pigment can be cationic and the polymeric dispersing agent can be anionic, and vice versa. In other examples, the polymeric dispersant can associate through adsorption, hydrogen bonding, or other similar attractions. In further detail, the polymeric dispersing agent can be any polymeric material that can be used to disperse the carbon black pigment, but is not to be confused with the polymeric binder described elsewhere herein. The polymeric dispersant can be, for example, ionic in nature, and can disperse or suspend the carbon black pigments that would otherwise clump together and settle out of the liquid vehicle. Ionic polymers disperse the pigment by being adsorbed or otherwise attracted to the surface of the pigment particles. Two principal mechanisms of stabilization provided by the polymeric dispersant can include steric stabilization and electrostatic stabilization. Steric stabilization occurs when the outer surface of a colored pigment becomes completely surrounded by ionic polymer, thereby preventing individual pigments from clumping together. Electrostatic stabilization occurs when the outer surface of the pigment becomes essentially equally charged (or charged at least enough to remain suspended) in the suspension fluid. Thus, Coulomb-repulsion can prevent individual pigments from clumping together. Regardless of the mechanism of action, the polymeric dispersant can be, for example, a polyurethane-based dispersion, e.g., a styrene-acrylic dispersant or polyurethane dispersant. In one example, the polymeric dispersant can be a polyurethane-based dispersant, such as Solsperse® M387, Solsperse® 22000 (available from Lubrizol Advanced Materials, Inc., Ohio), or a combination thereof.

In some examples, ink compositions can further include other solid or liquid components. For example, the ink composition can further include a co-solvent. In one example, the co-solvent can include a carbonyl functional group, an alcohol functional group, a ketone functional group, an ester functional group, or combinations thereof. In one example, the co-solvent can be a carbonyl co-solvent. Exemplary carbonyl co-solvents can include acetone, diacetone alcohol, or combinations thereof.

In other examples, the co-solvent can be an alcohol such as methanol or other alcohol other than ethanol or a C₃ to C₆ alcohol. In yet other examples, the co-solvent can be a ketone, such as methyl ethyl ketone. In another example, the co-solvent can be an ester, such as ethyl acetate. When present, the co-solvent, regardless of type, can be present at from 0.5 wt % to 15 wt %, from 1 wt % to 12 wt %, or from 5 wt % to 10 wt %. Thus, “co-solvent” as described herein does not include water, ethanol, or C₃ to C₆ alcohol, as the ink compositions of the present disclosure non-aqueous (only trace amounts of water allowable, e.g., less than 1 wt %), and the ethanol and C₃ to C₆ alcohol solvents are already accounted for in the ink composition.

In one example, the ink composition can further include an additive such as a decap additive, an additive to improve kogation (e.g., a “koga additive”), surfactant, and/or the like. An exemplary decap additive can include perflouropolyethers, such as Fluorolink® A10P (available from Solvay, Colo. When present, the decap additive can range from 0.01 wt % to 1 wt %, from 0.05 w to 0.75 wt %, or from 0.1 wt % to 0.5 wt %. An exemplary koga additive can include an isotridecyl phosphate such as Crodafos™ T6A (available from Croda® International Plc, England), and the like. When present, the amount of the koga additive can vary from 0.01 wt % to 1 wt %, from 0.05 wt % to 0.8 wt %, or from 0.1 wt % to 0.4 wt %.

In further detail, the present disclosure is drawn to an inkjet printing system. The system can include a non-porous polymeric substrate and a non-aqueous ink composition, as described above. As used herein, a non-porous polymeric substrate can be a polymeric substrate having varying degrees of permeability to air and moisture, but can be substantially devoid of pores. In other example, the non-porous polymeric substrate can be coated or surface treated, or can be uncoated or without surface treatment. Exemplary non-porous polymeric substrates can include polyvinyl chloride, a polyethylene, such as a low density polyethylene (density less than about 0.93 g/cm³) or a high density polyethylene (density from about 0.93 to 0.97 g/cm³), a polyethylene terephthalate, a polyproplyene, a polystyrene, a polylactic acid, or a polymeric blend thereof. In some examples, the non-porous polymeric substrate can be a biaxially-oriented substrate. In yet other examples, the non-porous polymeric substrate can be biaxially-oriented polypropylene film. As used herein, a “biaxially-oriented” substrate refers to a substrate that has a stretched crystal or structural orientation in at least two directions or axes. This process can generate non-porous polymeric films that can have a higher tensile strength (per given thickness), greater stiffness, enhanced fluid barrier, etc. Oriented substrates can have less permeability and can thereby limit diffusion. Because these substrates tend to have enhanced fluid barrier properties, printing on biaxially-oriented substrates can be particularly challenging in some examples. One example application for printing on these and other types of non-porous polymeric substrate include, food packaging, where the ink composition can be used to image sell by dates and/or barcodes on the packaging. When printing barcodes, enhanced durability and optical density can be beneficial.

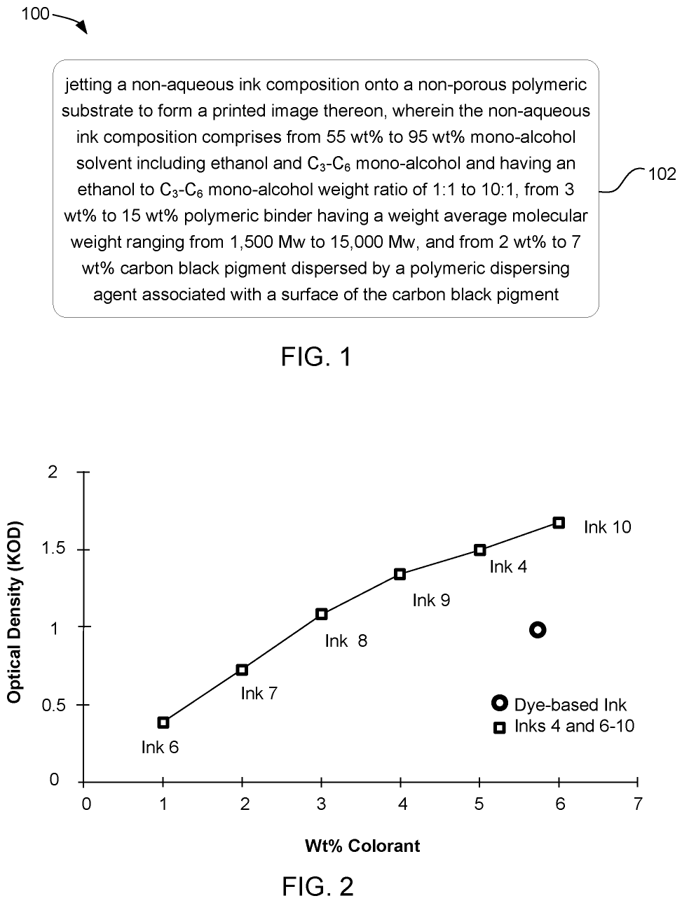

Further presented herein is a method of printing. In one example as can be seen in FIG. 1, the method 100 can include jetting 102 a non-aqueous ink composition onto a non-porous polymeric substrate to form a printed image thereon. The non-aqueous ink composition can include from 55 wt % to 95 wt % mono-alcohol solvent and can include ethanol and C₃-C₆ mono-alcohol, from 3 wt % to 15 wt % polymeric binder, and from 2 wt % to 7 wt % carbon black pigment. The mono-alcohol solvent can have an ethanol to C₃-C₆ mono-alcohol weight ratio of 1:1 to 10:1. The polymeric binder can have a weight average molecular weight ranging from 1,500 Mw to 15,000 Mw. The carbon black pigment can be dispersed by a polymeric dispersing agent associated with a surface of the carbon black pigment. The non-porous polymeric substrate and the components of the ink composition can be as described above. In this example, each of the details described herein with respect to the non-aqueous ink composition and the non-porous polymeric substrate can be applicable to the method.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

The term “non-porous” refers to media that can have a low surface tension and have poor fluid permeability, absorption, and/or adsorption. Non-limiting examples include polyvinyl chloride, polyethylene, polyethylene terephthalate, polyproplyene, polystyrene, polylactic acid, or blends thereof. The non-porous polymeric substrate may be formed exclusively of plastic or polymer, or may be formed of a substrate formed from a different material coated with a plastic or polymer coating, e.g., polymer or plastic coated cellulose diacetate, cellulose triacetate, cellulose propionate, cellulose butyrate, cellulose acetate butyrate, nitrocellulose, etc.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of 1 wt % to 20 wt % should be interpreted to include not only the explicitly recited limits of 1 wt % and 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following illustrates examples of the present disclosure. However, it is to be understood that the present examples are only illustrative of the principles set forth herein. Numerous modifications may be devised by those skilled in the art without departing from the spirit and scope of the present disclosure. The appended claims are intended to cover such modifications and arrangements. Thus, while the technology has been described above with particularity, the following provides further detail in connection with what aree presently deemed to be the acceptable examples.

### Example 1

### Non-Aqueous Ink Composition

Several different ink compositions were formulated. The ingredients in the non-aqueous ink composition, other than the pigment dispersion, were admixed. Then the pigment dispersions were slowly added with other ingredients and the resultant mixture was further admixed for at least two hours to form several different non-aqueous ink composition. The ingredients in the non-aqueous ink compositions that were formulated are shown in Tables 1-4 below.

TABLE 1
Non-Aqueous Ink Compositions

| | | Dye- | | | | | |
|---|---|---|---|---|---|---|---|
| | | based Ink | Ink 1 | Ink 2 | Ink 3 | Ink 4 | Ink 5 |
| Component | Type | (wt %) | (wt %) | (wt %) | (wt %) | (wt %) | (wt %) |
| Ethanol | Ethanol | 77 | 83.73 | 81.23 | 84.23 | 81.23 | 81.23 |
| (SDA 40B 200 Proof) | Solvent | | | | | | |
| Cyclohexanone | Carbonyl | 9 | — | — | — | — | — |
| | Co-Solvent | | | | | | |
| Acetone | Carbonyl | 6 | 6 | 6 | 6 | 6 | 6 |
| | Co-Solvent | | | | | | |
| Fluorolink ® A10P | Decap | 0.3 | 0.3 | 0.3 | 0.3 | 0.3 | 0.3 |
| (perfluoropolyether) | Additive | | | | | | |
| Crodafos ™ T6A | Koga | 0.2 | 0.2 | 0.2 | 0.2 | 0.2 | 0.2 |
| (POE isotridecyl | Additive | | | | | | |
| phosphate) | | | | | | | |
| Valifast ® Black 3808 | Dye | 4.8 | — | — | — | — | — |
| Orasol ® Orange 247 | Dye | 0.9 | — | — | | — | — |
| Nipex ® 160IQ | Pigment | — | 5 | 5 | 5 | 5 | 5 |
| (carbon black) | | | | | | | |
| Solsperse ® M387 | Dispersant | — | 2.27 | 2.27 | 2.27 | 2.27 | 2.27 |
| (polyurethane | | | | | | | |
| dispersant) | | | | | | | |
| Neocryl ® B-818 | Polymeric | 1.8 | 2.50 | 5 | — | — | — |
| (acrylic co-polymer) | Binder | | | | | | |
| Joncryl ® Eco 684 | Polymeric | — | — | — | — | — | 5 |
| (Styrene Acrylic) | Binder | | | | | | |
| Variplus ® SK | Polymeric | — | — | — | 2 | 5 | — |
| (polyol resin based on | Binder | | | | | | |
| hydrogenated phenyl | | | | | | | |
| ketone resin) | | | | | | | |

TABLE 2
Non-Aqueous Ink Compositions

| | | Ink 6 | Ink 7 | Ink 8 | Ink 9 | Ink 10 | Ink 11 |
|---|---|---|---|---|---|---|---|
| Component | Type | (wt %) | (wt %) | (wt %) | (wt %) | (wt %) | (wt %) |
| Ethanol | Ethanol | 87.05 | 85.59 | 84.14 | 82.68 | 80.78 | 61.23 |
| (SDA 40B 200 Proof) | Solvent | | | | | | |
| 1-Propanol | C₃-C₆ | — | — | — | — | — | 20 |
| | Alcohol | | | | | | |
| | Solvent | | | | | | |
| Acetone | Carbonyl | 6 | 6 | 6 | 6 | 6 | 6 |
| | Co-Solvent | | | | | | |
| Fluorolink ® A10P | Decap | 0.3 | 0.3 | 0.3 | 0.3 | 0.3 | 0.3 |
| (perfluoropolyether) | Additive | | | | | | |
| Crodafos ™ T6A | Koga | 0.2 | 0.2 | 0.2 | 0.2 | 0.2 | 0.2 |
| (POE isotridecyl phosphate) | Additive | | | | | | |
| Nipex ® 160IQ | Pigment | 1 | 2 | 3 | 4 | 6 | 5 |
| (carbon black) | | | | | | | |
| Solsperse ® M387 | Dispersant | 0.45 | 0.91 | 1.36 | 1.82 | 2.72 | 2.27 |
| (polyurethane dispersant) | | | | | | | |
| Variplus ® SK | Polymeric | 5 | 5 | 5 | 5 | 5 | 5 |
| (polyol resin based on | Binder | | | | | | |
| hydrogenated phenyl ketone | | | | | | | |
| resin) | | | | | | | |

TABLE 3
Non-Aqueous Ink Compositions

| | | Ink 12 | Ink 13 | Ink 14 | Ink 15 | Ink 16 | *Ink 17 |
|---|---|---|---|---|---|---|---|
| Component | Type | (wt %) | (wt %) | (wt %) | (wt %) | (wt %) | (wt %) |
| Ethanol | Ethanol | 61.23 | 61.23 | 61.23 | 61.23 | 71.23 | 61.23 |
| (SDA 40B 200 Proof) | Solvent | | | | | | |
| 1-Propanol | C₃-C₆ Alcohol | 17 | 10 | 3 | — | — | — |
| | Solvent | | | | | | |
| 1-Butanol | C₃-C₆ Alcohol | 3 | 10 | 17 | 20 | 10 | 20 |
| | Solvent | | | | | | |
| Acetone | Carbonyl | 6 | 6 | 6 | 6 | 6 | 6 |
| | Co-Solvent | | | | | | |
| Fluorolink ® A10P | Decap Additive | 0.3 | 0.3 | 0.3 | 0.3 | 0.3 | 0.3 |
| (perfluoropolyether) | | | | | | | |
| Crodafos ™ T6A (POE | Koga Additive | 0.2 | 0.2 | 0.2 | 0.2 | 0.2 | 0.2 |
| isotridecyl phosphate) | | | | | | | |
| Nipex ® 160IQ | Pigment | 5 | 5 | 5 | 5 | 5 | 5 |
| (carbon black) | | | | | | | |
| Solsperse ® M387 | Dispersant | 2.27 | 2.27 | 2.27 | 2.27 | 2.27 | 2.27 |
| (polyurethane dispersant) | | | | | | | |
| Variplus ® SK | Polymeric | 5 | 5 | 5 | 5 | 5 | 5 |
| (polyol resin based on | Binder | | | | | | |
| hydrogenated phenyl | | | | | | | |
| ketone resin) | | | | | | | |

*Ink 17 is identical to Ink 15, but is identified separately in Table 3 because this particular ink was tested for Dry Time and Smearing in Tables 7 and 8, respectively, on two separate days with slightly different results.

TABLE 4
Non-Aqueous Ink Compositions

| | | Ink 18 | Ink 19 | Ink 20 | Ink 21 | Ink 22 | Ink 23 | Ink 24 |
|---|---|---|---|---|---|---|---|---|
| Component | Type | (wt %) | (wt %) | (wt %) | (wt %) | (wt %) | (wt %) | (wt %) |
| Ethanol | Ethanol | 51.23 | 41.23 | 80.23 | 79.23 | 78.23 | 77.23 | 76.23 |
| (SDA 40B 200 Proof) | Solvent | | | | | | | |
| 1-Butanol | C₃-C₆ | 30 | 40 | — | — | — | — | — |
| | Alcohol | | | | | | | |
| | Solvent | | | | | | | |
| Acetone | Carbonyl | 6 | 6 | 6 | 6 | 6 | 6 | 6 |
| | Co-Solvent | | | | | | | |
| Fluorolink ® A10P | Decap | 0.3 | 0.3 | 0.3 | 0.3 | 0.3 | 0.3 | 0.3 |
| (perfluoropolyether) | Additive | | | | | | | |
| Crodafos ™ T6A | Koga | 0.2 | 0.2 | 0.2 | 0.2 | 0.2 | 0.2 | 0.2 |
| (POE isotridecyl | Additive | | | | | | | |
| phosphate) | | | | | | | | |
| Nipex ® 160IQ | Pigment | 5 | 5 | 5 | 5 | 5 | 5 | 5 |
| (carbon black) | | | | | | | | |
| Solsperse ® M387 | Dispersant | 2.27 | 2.27 | 2.27 | 2.27 | 2.27 | 2.27 | 2.27 |
| (polyurethane | | | | | | | | |
| dispersant) | | | | | | | | |
| Variplus ® SK | Polymeric | 5 | 5 | 6 | 7 | 8 | 9 | 10 |
| (polyol resin based | Binder | | | | | | | |
| on hydrogenated | | | | | | | | |
| phenyl ketone resin) | | | | | | | | |

In Tables 1-4 above:
Flurolink ® A10P is available from Solvay (Colorado);
Crodafos ™ is available from Croda ® International Plc (England);
Neocryl ® B-818 is available from DSM coating and Resins, LLC (Netherlands);
Valifast ® Black 3808 is available from Orient Chemical Ind. Ltd (Japan);
Orasol ® Orange 247 is available from BASF Corp. (New Jersey);
Variplus ® SK is available from Tego ® Evonik Resource Efficiency GmbH (Germany);
Nipex ® 1601Q is available from Orion Engineered Carbons, GmbH Ltd. (Germany) - modified by co-milling with polymeric dispersant at HP, Inc. (California);
Solsperse ™ M387 is available from Lubrizol Advanced Materials, Inc. (Ohio); and
Joncryl ® Eco 684 and 685 are available from BASF Corp. (New Jersey).

### Example 2

### Durability

The comparative ink formulation (Dye-based Ink) and Inks 1-5 (see Table 1 above) were tested for their durability by printing a sample having 5 bars on treated biaxially-oriented polypropylene film using an HP® ink jet printer Motiv6. Each print was allowed to rest for two hours. After two hours, a rub-tester, TMI® (Testing Machines Inc, New York) model #10-1801-0001 was fitted with a blue glove having one drop squalene oil applied at the tip. Each print was rubbed 24 times in three spots at a pressure of 30 psi. The prints were then scanned using an Epson® V5000 Office Scanner (Seiko Epson Corp., Japan) and the percent fade was calculated by dividing the optical density of the rubbed area by the optical density of the areas that were not rubbed. The percent fade was calculated using QEA® IAS 2000-D software (Quality Engineering Associates, Inc, Massachusetts). The results of the rub test are shown in Table 5 below.

TABLE 5
Percent Fade

| | Dye- | | | | | |
|---|---|---|---|---|---|---|
| | based Ink | Ink 1 | Ink 2 | Ink 3 | Ink 4 | Ink 5 |
| Percent Fade (KOD) | 100 | 100 | 100 | 100 | 38 | 30 |

As can be seen in Table 5 above, Inks 4 and 5 provided good durability. These inks incorporated 5 wt % of Variplus® SK (Tego® Evonik Resource Efficiency GmbH, (Germany)) and Joncryl® Eco 684 (BASF Corp. (New Jersey)), respectively, as a binder. These binders contain an aryl group and each have a molecular weight below 8,000 Mw (higher than 1,500 Mw). Ink 3 incorporated Joncryl® Eco 684; however it was incorporated at 2 wt %, which in this example was not enough to generate improved durability under these testing conditions.

### Example 3

### Viscosity

These inks were also tested for viscosity using a Brookfield viscometer. The viscosity was measured at 100 rpm and 25° C., and the data is shown in Table 6 below.

TABLE 6
Viscosity

| | Dye- | | | | | |
|---|---|---|---|---|---|---|
| | based Ink | Ink 1 | Ink 2 | Ink 3 | Ink 4 | Ink 5 |
| Viscosity (cps) | 1.80 | 2.73 | 4.06 | 1.87 | 2.18 | 2.50 |

The viscosity of the inks 4 and 5 was within an acceptable range for jettabiity.

### Example 4

### Optical Density

The comparative ink formulation, i.e. Dye-based Ink, and Inks 4, and 6-10 (see Tables 1 and 2 above) were tested for optical density using a Spectrolino® D50 Gretag-Macbeth AG Joint Stock Corp., Switzerland) light source. As can be seen in FIG. 2 the optical density of Inks 4 and 8-10 was greater than 1 KOD and Inks 6-7 were less than 1 KOD. Interestingly, the Dye-based Ink (control) and Ink 8 exhibited about the same optical density, e.g., about 1 KOD, but Ink 8 only used about 3 wt % of pigment colorant, whereas the Dye-based Ink incorporated 5.7 wt % of dye colorant. Accordingly, the carbon black pigment dispersion based ink can obtain an optical density of about 1 KOD or higher using less pigment than was present in the comparative Dye-based Ink used generate about the same optical density. Thus, ink formulations having fewer solids added by virtue of the colorant can be formulated, leaving more room for the addition of other solids, e.g., polymeric binder, etc., and/or leaving more room to formulate ink composition with lower viscosities if viscosity is a concern for a specific ink composition formulation.

### Example 5

### Dry Time

The comparative Dye-based Ink and Inks 4, and 11-19 (see Tables 1, 3, and 4 above) were tested for dry time. The testing involved printing 9 barcodes for each ink on treated biaxially-oriented polypropylene film, using an HP® ink jet printer Motiv6. For each ink, a reference barcode was allowed to completely air dry (for comparison) for about 1 hour. The other 8 barcodes per ink were wiped with a print eraser having a pressure of 20 psi and a downward force of 1.8 N at 3 seconds, 5 seconds, 7 seconds, 10 seconds, 20 seconds, 30 seconds, 40 seconds, or 50 seconds and the amount of smear was recorded. Drying occurred at room temperature (about 20° C. to 25° C.) and humidity ranged from 20% to 57%. The amount of smear at each time period was then compared to the reference barcode in order to determine the level of smearing. Smearing is indicated below in Tables 7 and 8 as “No” smearing, “Light” smearing, “Moderate” smearing, or “Heavy” smearing.

TABLE 7
Dry Time and Smearing

| | | Dye- | | | | | | |
|---|---|---|---|---|---|---|---|---|
| Time | | based Ink | Ink 4 | Ink 11 | Ink 12 | Ink 13 | Ink 14 | Ink 15 |
| 3 | seconds | Light | Heavy | Heavy | Heavy | Heavy | Heavy | Heavy |
| 5 | seconds | Light | Heavy | Heavy | Heavy | Moderate | Moderate | Moderate |
| 7 | seconds | Light | Heavy | Heavy | Heavy | Moderate | Moderate | Light |
| 10 | seconds | No | Heavy | Heavy | Moderate | Light | Moderate | Light |
| 20 | seconds | No | Heavy | Moderate | Moderate | Light | Light | Light |
| 30 | seconds | No | Heavy | Moderate | Moderate | Light | Light | Light |
| 40 | seconds | No | Heavy | Moderate | Light | Light | Light | No |
| 50 | seconds | No | Heavy | Light | Light | No | No | No |

TABLE 8
Dry Time and Smearing

| Time | | Ink 16 | Ink 17 | Ink 18 | Ink 19 |
|---|---|---|---|---|---|
| 3 | seconds | Heavy | Heavy | Heavy | Heavy |
| 5 | seconds | Heavy | Moderate | Heavy | Heavy |
| 7 | seconds | Moderate | Moderate | Moderate | Heavy |
| 10 | seconds | Moderate | Moderate | Light | Moderate |
| 20 | seconds | Light | Light | No | Light |
| 30 | seconds | Light | Light | No | Light |
| 40 | seconds | Light | Light | No | No |
| 50 | seconds | No | Light | No | No |

Using the Dye-based Ink as an aspirational benchmark with respect to dry time and smearing, as can be seen in Tables 7 and 8 above, in general, the dry time decreased as the amount of 1-butaol was increased in the ink composition. In other words, it took less drying time to reach “Light” smearing or even “No” smearing as more 1-butanol was added compared to the 1-propanol. That being stated, the 1-propanol also is provide some dry time effect improvement, but the inclusion of 1-butanol at greater concentrations had a more significant impact on the drying time of pigmented inks.

### Example 6

### Viscosity Testing of Inks With Increasing Amounts of 1-Butanol

The viscosity of Inks 16-19 were tested in order to determine the impacts of increasing the amount of 1-butanol in the formulation on viscosity. Viscosity was tested using a Brookfield viscometer at 100 rpm and 25° C., and the data is shown in Table 9 below.

TABLE 9
Viscosity

| | Dye- | | | | |
|---|---|---|---|---|---|
| | based Ink | Ink 16 | Ink 17 | Ink 18 | Ink 19 |
| Viscosity (cps) | 1.80 | 2.42 | 2.61 | 2.80 | 3.05 |

As can be seen above, the viscosity of the ink increased as the amount of 1-butanol in the ink composition increased, but were still generally within acceptable viscosity ranges. As jettability issues may begin to occur in some examples, a balance between a lower concentration of 1-butanol and acceptable dry time can be balanced, depending on the exact non-aqueous ink composition formulated for a given application.

### Example 7

### Durability and Viscosity With Increased Polymeric Binder Concentrations

Inks 20-24 (see Table 4 above) were tested for their durability using the methodology explained in Example 2 and viscosity using the methodology described in Example 3. These inks did not include the added C3 to C6 alcohol, but were included to verify that the printed inks could still be durably printed (albeit drying slower), and had desirable viscosity for inkjet printing technology. The results of the rub test (after drying for 2 hours) are shown in Table 11 below.

TABLE 10
Percent Fade

| | Ink 20 | Ink 21 | Ink 22 | Ink 23 | Ink 24 |
|---|---|---|---|---|---|
| Percent Fade (KOD) | 36 | 31 | 31 | 27 | 24 |

Furthermore, each of Inks 20-24 exhibited a viscosity suitable for inkjet printing from a thermal inkjet printhead, for example, as shown in Table 11 below.

TABLE 11
Viscosity

| | Ink 20 | Ink 21 | Ink 22 | Ink 23 | Ink 24 |
|---|---|---|---|---|---|
| Viscosity (cps) | 2.73 | 2..92 | 2.98 | 3.15 | 3.32 |

While the present technology has been described with reference to certain specific examples, those skilled in the art will appreciate that various modifications, changes, omissions, and substitutions can be made without departing from the spirit of the disclosure. It is intended, therefore, that the disclosure be limited only by the scope of the following claims.

What is claimed is:

1. A non-aqueous ink composition, comprising:
from 55 wt % to 95 wt % mono-alcohol solvent including ethanol and C₃-C₆ mono-alcohol having an ethanol to C₃-C₆ mono-alcohol weight ratio of 1:1 to 10:1;
from 3 wt % to 15 wt % polymeric binder having a weight average molecular weight ranging from 1,500 Mw to 15,000 Mw; and
from 2 wt % to 7 wt % carbon black pigment dispersed by a polymeric dispersing agent associated with a surface of the carbon black pigment.

2. The non-aqueous ink composition of claim 1, wherein the ethanol is present in the non-aqueous ink composition at from 45 wt % to 85 wt %, and wherein the C₃-C₆ mono-alcohol is present in the non-aqueous ink composition at from 10 wt % to 50 wt %

3. The non-aqueous ink composition of claim 1, wherein the C₃-C₆ mono-alcohol is one or more straight chained mono-alcohol.

4. The non-aqueous ink composition of claim 1, wherein the C₃-C₆ mono-alcohol includes 1-butanol.

5. The non-aqueous ink composition of claim 1, further comprising from 0.5 wt % to 15 wt % of a carbonyl co-solvent.

6. The non-aqueous ink composition of claim 1, wherein the polymeric binder is styrene acrylic copolymer, a hydrogenated phenyl ketone resin, or a combination thereof.

7. The non-aqueous ink composition of claim 1, wherein the carbon black is present at from 3 wt % to 6 wt % in the non-aqueous ink composition, and wherein the non-aqueous ink composition is devoid of dye.

8. An inkjet printing system, comprising;
a non-porous polymeric substrate; and
a non-aqueous ink composition including from 55 wt % to 95 wt % mono-alcohol solvent including ethanol and C₃-C₆ mono-alcohol having an ethanol to C₃-C₆ mono-alcohol weight ratio of 1:1 to 10:1, from 3 wt % to 15 wt % polymeric binder having a weight average molecular weight ranging from 1,500 Mw to 15,000 Mw, and from 2 wt % to 7 wt % carbon black pigment dispersed by a polymeric dispersing agent associated with a surface of the carbon black pigment.

9. The system of claim 8, wherein the non-porous polymeric substrate is a biaxially-oriented substrate.

10. The system of claim 8, wherein the non-porous polymeric substrate is a polyvinyl chloride, a polyethylene, a polyethylene terephthalate, a polyproplyene, a polystyrene, a polylactic acid, or a polymeric blend thereof.

11. The system of claim 8, wherein C₃-C₆ mono-alcohol includes 1-butanol.

12. A method of printing, comprising jetting a non-aqueous ink composition onto a non-porous polymeric substrate to form a printed image thereon, wherein the non-aqueous ink composition comprises from 55 wt % to 95 wt % mono-alcohol solvent including ethanol and C₃-C₆ mono-alcohol and having an ethanol to C₃-C₆ mono-alcohol weight ratio of 1:1 to 10:1, from 3 wt % to 15 wt % polymeric binder having a weight average molecular weight ranging from 1,500 Mw to 15,000 Mw, and from 2 wt % to 7 wt % carbon black pigment dispersed by a polymeric dispersing agent associated with a surface of the carbon black pigment.

13. The method of claim 12, wherein the non-porous polymeric substrate is a biaxially-oriented substrate.

14. The method of claim 12, wherein the non-porous polymeric substrate is a polyvinyl chloride, a polyethylene, a polyethylene terephthalate, a polyproplyene, a polystyrene, a polylactic acid, or a polymer blend thereof.

15. The method of claim 12, wherein C₃-C₆ mono-alcohol includes 1-butanol.
